(19) United States
(12) Patent Application Publication
(10) Pub. No.: US 2015/0186219 A1
(43) Pub. Date: Jul. 2, 2015

(54) ELECTRONIC DEVICE AND METHOD FOR TRACKING OPERATIONS OF DIFFERENT USERS

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: MIN YANG, Wuhan (CN); XIN-SHU WANG, Wuhan (CN); JIAN-HUNG HUNG, New Taipei (TW)

(21) Appl. No.: 14/546,496

(22) Filed: Nov. 18, 2014

(30) Foreign Application Priority Data
Dec. 30, 2013 (CN) 201310745946.6

(51) Int. Cl. G06F 11/14; G06F 21/62; G06F 17/30

(52) U.S. Cl. CPC G06F 11/1451; G06F 17/30088; G06F 21/6218; G06F 2201/84

(57) ABSTRACT

An operation tracking method creates a database recording unique identifiers of users and operation listings of the users. The method records operation information of the user in the operation listing of the user, and recovers each finalized data to the corresponding original data according to the operation information of the user when the user logs out of the electronic device. The method further recognizes the unique identifier of a current user when the current user logs into the electronic device, and recovers each original data to the corresponding finalized data according to the operation information of the current user recorded in the operation listings of the current user corresponding to the unique identifier of the current user.

### CROSS-REFERENCE TO RELATED APPLICATIONS

This application claims priority to Chinese Patent Application No. 201310745946.6 filed on Dec. 30, 2013, the contents of which are incorporated by reference herein.

### FIELD

The subject matter herein generally relates to electronic devices, and particularly to an electronic device and method for tracking operations of different users.

### BACKGROUND

Different users can log in and use an electronic device via different user accounts. When a user logs in the electronic device via a corresponding user account, the data stored in the electronic device, such as software, documents, and the like, can be edited by the user. However, when another user logs in the electronic device via his/her corresponding user account, the data stored in the electronic device and presented to the another user is the same as the data edited by the user.

### BRIEF DESCRIPTION OF THE DRAWINGS

Implementations of the present technology will now be described, by way of example only, with reference to the attached figures.

FIG. 1 is a block diagram of an embodiment of an electronic device.

FIG. 2 illustrates a flowchart of an embodiment of an operation tracking method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device. The term “comprising” means “including, but not necessarily limited to”; it specifically indicates open-ended inclusion or membership in a so-described combination, group, series and the like.

Embodiments of the present disclosure will be described with reference to the accompanying drawings.

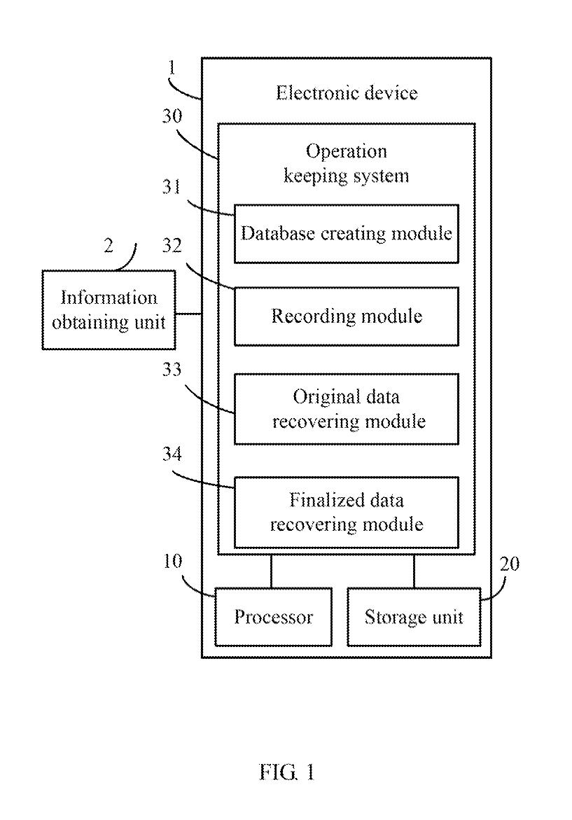

FIG. 1 shows an embodiment of an electronic device 1. The electronic device 1 can track operations of different users. Each user can include a unique identifier. Each unique identifier can be one or more selected from a group consisting of an account, a password, and biometrics information. The biometrics information can include, but is not limited to, facial feature, fingerprint, and retinal image. In the embodiment, the electronic device 1 can be connected to an information obtaining unit 2 located external relative to the electronic device 1. In other embodiments, the information obtaining unit 2 can be built in the electronic device 1. The information obtaining unit 2 can obtain biometrics information of a user. In the embodiment, the information obtaining unit 2 can include, but not limited to, a camera, a fingerprint obtaining unit, or a retinal image obtaining unit. The camera can obtain the facial features of the user. The fingerprints obtaining unit can obtain the fingerprint of the user. The retinal image obtaining unit can obtain the retinal image of the user. The electronic device 1 can store a number of data which can be edited, such as software, documents, and the like.

The electronic device 1 can create a database, obtain the unique identifiers of the users, and add the unique identifiers of the users and operation listings of the users into the database. The electronic device 1 can record operation information of the user on the data stored in the electronic device 1 into the operation listing of the corresponding user, and recover original data according to the operation information of the user when the user logs out of the electronic device 1. The electronic device 1 can further recognize the unique identifier of a current user when the current user logs in the electronic device 1, determine the operation listing of the current user corresponding to the unique identifier of the current user, and recover finalized data according to the determined operation information of the current user recorded in the operation listing of the current user.

In at least one embodiment, the electronic device 1 can include a processor 10 and a storage unit 20. An operation tracking system 30 can be applied in the electronic device 1. In at least one embodiment, the operation tracking system 30 can include a database creating module 31, a recording module 32, an original data recovering module 33, and a finalized data recovering module 34. One or more programs of the above function modules can be stored in the storage unit 20 and executed by the processor 10. The processor 10 can be a central processing unit, a digital signal processor, or a single chip, for example. The storage unit 20 can be a hard disk, a compact disk, or a flash memory, for example.

The database creating module 31 can be configured to create a database, obtain the unique identifiers of the users, and add the unique identifiers of the users and the operation listings of the users into the database. Each unique identifier can correspond to one operation listing. In the embodiment, the database creating module 31 can be further configured to obtain the unique identifier of the user when the user logs in the electronic device via the unique identifier of the user, and search the database to determine whether the obtained unique identifier of the user matches one stored unique identifier of the user. The database creating module can be further configured to add the obtained unique identifier of the user and the corresponding operation listing of the user into the database when the obtained unique identifier of the user does not match one stored unique identifier of the user.

The recording module 32 can be configured to determine the operation listing corresponding to the unique identifier of the user when the user logs in the electronic device 1 via the unique identifier of the user, record operation information of the user on the data stored in the electronic device 1 into the determined operation listing of the corresponding user, and store the original data which is edited. In the embodiment, the operation information can include information of the edited content of each original data and corresponding information of the edited content of the finalized data. The information of the edited content can include a filename, a storage address, and contents.

In the embodiment, the recording module 32 can store the original data which is edited by hiding the original data or moving the original data to a preset storage area, to just present the finalized data to the user. In detail, when the size of the original data is greater than a preset value, such as 100 megabit, the recording module 32 can hide the original data. When the size of the original data is less than or equal to the preset value, the recording module 32 can move the original data to the preset storage area.

The original data recovering module 33 can be configured to recover each finalized data to corresponding original data according to the operation information of the user recorded in the operation listing of the user when the user logs out of the electronic device 1.

In detail, the original data recovering module 33 can determine the operation information of the user recorded in the determined operation listing of the user, and determine each finalized data according to the filename of each finalized data of the determined operation information of the user and the storage address of each finalized data of the determined operation information of the user. The original data recovering module 33 can further determine each original data according to the filename of each original data of the determined operation information of the user and the storage address of each original data of the determined operation information of the user, and recover each determined finalized data and the storage address of each determined finalized data to the corresponding determined original data and the corresponding storage address of the original data.

For example, when the filename of the finalized data and the corresponding storage address of the finalized data recorded in the operation listing of the user are respectively A and D:\, and the filename of the original data and the corresponding storage address of the original data recorded in the operation listing of the user are respectively B and E:\, the original data recovering module 33 determines the data according to the filename of the finalized data A and the storage address of the original data D:\, recovers the filename of the finalized data from A to B, and recovers the storage address of the finalized data from D:\ to E:\.

In the embodiment, when the original data is hid, the original data recovering module 33 can recover the original data by showing the hid original data. When the original data is stored to the preset storage area, the original data recovering module 33 can recover the original data by moving the original data from the preset storage area to a storage area corresponding to the storage address of the original data.

The finalized data recovering module 34 can be configured to recognize the unique identifier of a current user when the current user logs into the electronic device 1, determine the operation listing of the current user corresponding to the unique identifier of the current user, and recover each original data to corresponding finalized data according to the operation information of the current user recorded in the operation listing of the current user. In the embodiment, the finalized data recovering module 34 can be further configured to search the database to determine whether the unique identifier of the current user matches one stored unique identifier of the user, and determine the operation listing of the current user corresponding to the unique identifier of the current user when the unique identifier of the current user matches one stored unique identifier of the user.

The detail whereby the finalized data recovering module 34 recovers each original data to the corresponding finalized data according to the operation information of the user recorded in the determined operation listing of the current user will be described as following: the finalized data recovering module 34 can determine the operation information of the current user recorded in the determined operation listing of the current user, and determine each original data according to the filename of each original data of the determined operation information of the current user and the storage address of each original data of the determined operation information of the current user. The finalized data recovering module 34 can further replace the information of the edited content of each original data with the corresponding information of the edited content of the finalized data, to recover each original data to the corresponding finalized data.

For example, when the filename of the finalized data and the corresponding storage address of the finalized data recorded in the operation listing of the user are respectively G and I:\, and the filename of the original data and the corresponding storage address of the original data recorded in the operation listing of the user are respectively H and J:\ the finalized data recovering module 34 determines the data according to the filename of the original data G and the storage address of the original data I:\, replaces filename of the data from G to H, and replaces storage address of the data from I:\ to J:\.

In the embodiment, the recording module 32 can be further configured to delete the information of the edited content of each finalized data recorded in the operation listing of the current user when the finalized data recovering module 34 recovers each original data to the corresponding finalized data.

In the embodiment, the database can further store permissions of the users. Each permission can correspond to one unique identifier. In the embodiment, different permissions can be defined, such as an ordinary permission or an administrator permission. The user with the administrator permission can be allowed to make the reality changes to the electronic device 1. For example, when the operation information of a user with the administrator permission is cancelling one data from the electronic device 1, the data can be canceled from the electronic device 1 in fact. The recording module 32 can determine the permission of the current user corresponding to the unique identifier of the current user, determine whether the permission of the current user is the administrator permission, replace the information of the edited content of each original data recorded in the operation listing of each user with the ordinary permission to the information of the edited content of each finalized data edited by the current user with the administrator permission, and store the finalized data edited by the current user with the administrator permission.

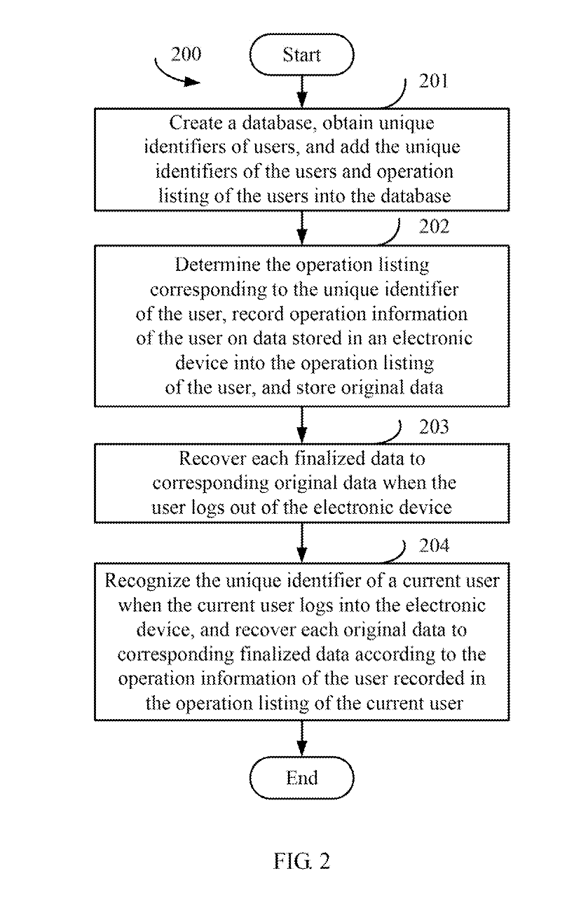

FIG. 2 illustrates a flowchart of an embodiment of an operation tracking method 200. The method 200 is provided by way of example, as there are a variety of ways to carry out the method 200. The method 200 described below can be carried out using the configurations illustrated in FIG. 1, for example, and various elements of these figures are referenced in the explanation of method. Each block shown in FIG. 2 represents one or more processes, methods, or subroutines carried out in the method. Additionally, the illustrated order of blocks is by example only and the order of the blocks can change. The method 200 can begin at block 201.

In block 201, a database creating module creates a database, obtains unique identifiers of users, and adds the unique identifiers of the users and operation listings of the users into the database. Each unique identifier corresponds to one operation listing.

In block 202, a recording module determines the operation listing corresponding to the unique identifier of the user when a user logs in an electronic device via the unique identifier of the user, records operation information of the user on data stored in the electronic device into the operation listing of the user, and stores original data which is edited. In the embodiment, the operation information includes information of the edited content of each original data and corresponding information of the edited content of the finalized data. The information of the edited content can include a filename, a storage address, and contents.

In block 203, an original data recovering module recovers each finalized data to corresponding original data according to the operation information of the user recorded in the operation listing of the user when the user logs out of the electronic device. In detail, the original data recovering module determines the operation information of the user recorded in the determined operation listing of the user, and determines each finalized data according to the filename of each finalized data of the determined operation information of the user and the storage address of each finalized data of the determined operation information of the user. The original data recovering module further determines each original data according to the filename of each original data of the determined operation information of the user and the storage address of each original data of the determined operation information of the user, and recovers each determined finalized data and the storage address of each determined finalized data to the corresponding determined original data and the corresponding storage address of the original data.

In block 204, a finalized data recovering module recognizes the unique identifier of a current user when the current user logs into the electronic device, determines the operation listing of the current user corresponding to the unique identifier of the current user, and recovers each original data to corresponding finalized data according to the operation information of the user recorded in the determined operation listing of the current user. The detail whereby the finalized data recovering module recovers each original data to the corresponding finalized data according to the operation information of the user recorded in the determined operation listing of the current user will be described as following: the finalized data recovering module determines the operation information of the current user recorded in the determined operation listing of the current user, and determines each original data according to the filename of each original data of the determined operation information of the current user and the storage address of each original data of the determined operation information of the current user. The finalized data recovering module further replaces the information of the edited content of each original data with the corresponding information of the edited content of the finalized data, to recover each original data to the corresponding finalized data.

In the embodiment, the method further includes: the database creating module obtains the unique identifier of the user when the user logs in the electronic device via the unique identifier of the user, and searches the database to determine whether the obtained unique identifier of the user matches one stored unique identifier of the user. The database creating module adds the obtained unique identifier of the user and the corresponding operation listing of the user into the database when the obtained unique identifier of the user matches one stored unique identifier of the user.

In the embodiment, the method further includes: the recording module determines whether the size of the original data is greater than a preset value. The recording module stores the original data which is edited by hiding the original data when the size of the original data is greater than the preset value, and the original data recovering module recovers the original data by showing the hid original data. The recording module stores the original data which is edited by moving the original data to the preset storage area when the size of the original data is less than or equal to the preset value, and the original data recovering module recovers the original data by moving the original data from the preset storage area to a storage area corresponding to the storage address of the original data.

In the embodiment, the method further includes: the recording module deletes the information of the edited content of each finalized data recorded in the operation listing of the current user when the finalized data recovering module recovers each original data to the corresponding finalized data.

In the embodiment, the method further includes: the recording module determines a permission of the current user corresponding to the unique identifier of the current user, determines whether the permission of the current user is an administrator permission, replaces the information of the edited content of each original data recorded in the operation listing of each user with the ordinary permission to the information of the edited content of each finalized data edited by the current user with the administrator permission, and stores the finalized data edited by the current user with the administrator permission.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. An electronic device comprising:
a storage system;
a processor; and
one or more programs stored in the storage system and executed by the processor, the one or more programs comprising:
a database creating module configured to create a database, obtain unique identifiers of users, and add the unique identifiers of the users and operation listings of the users into the database, each unique identifier corresponding to one operation listing;
a recording module configured to determine the operation listing corresponding to the unique identifier of the user when the user logs in the electronic device via the unique identifier of the user, record operation information of the user on data stored in the electronic device into the operation listing of the user, and store original data which is edited;
an original data recovering module configured to recover each finalized data to corresponding original data according to the operation information of the user recorded in the operation listing of the user when the user logs out of the electronic device; and
a finalized data recovering module configured to recognize the unique identifier of a current user when the current user logs into the electronic device, determine the operation listing of the current user corresponding to the unique identifier of the current user, and recover each original data to corresponding finalized data according to the operation information of the current user recorded in the operation listing of the current user.

2. The electronic device as described in claim 1, wherein:
the recording module is further configured to determine a size of the original data;
the recording module stores the original data which is edited by hiding the original data when the size of the original data is greater than a preset value, and the original data recovering module recovers the original data by showing the hid original data; and
the recording module stores the original data which is edited by moving the original data to a preset storage area when the size of the original data is less than or equal to the preset value, and the original data recovering module recovers the original data by moving the original data from the preset storage area to a storage area corresponding to the storage address of the original data.

3. The electronic device as described in claim 1, wherein the operation information comprising information of the edited content of each original data and information of the edited content of each finalized data.

4. The electronic device as described in claim 3, wherein the database stores the permissions of the users, each permission corresponding to one unique identifier, an ordinary permission and an administrator permission being defined, the recording module is further configured to:
determine the permission of the current user corresponding to the unique identifier of the current user, and determine whether the permission of the current user is the administrator permission; and
replace the information of the edited content of each original data recorded in the operation listing of each user with the ordinary permission to the information of the edited content of each finalized data edited by the current user with the administrator permission, and store the finalized data edited by the current user with the administrator permission.

5. The electronic device as described in claim 3, wherein the recording module is further configured to delete the information of the edited content of each finalized data recorded in the operation listing of the current user when the finalized data recovering module recovers each original data to the corresponding finalized data.

6. The electronic device as described in claim 3, wherein the information of the edited content comprises a filename, a storage address, and contents, and the original data recovering module is configured to:
determine the operation information of the user recorded in the operation listing of the user, and determine each finalized data according to the filename of each finalized data of the determined operation information of the user and the storage address of each finalized data of the determined operation information of the user; and
determine each original data according to the filename of each original data of the determined operation information of the user and the storage address of each original data of the determined operation information of the user, and recover each determined finalized data and the storage address of each determined finalized data to the corresponding original data and the corresponding storage address of the original data.

7. The electronic device as described in claim 3, wherein the information of the edited content comprises a filename, a storage address, and contents, and the finalized data recovering module is configured to:
determine the operation information of the current user recorded in the operation listing of the current user, and determine each original data according to the filename of each original data of the determined operation information of the current user and the storage address of each original data of the determined operation information of the current user; and
replace the information of the edited content of each original data with the corresponding information of the edited content of the finalized data, to recover each original data to the corresponding finalized data.

8. An operation tracking method comprising:
creating a database, obtaining unique identifiers of users, and adding the unique identifiers of the users and operation listings of the users into the database, each unique identifier corresponding to one operation listing;
determining the operation listing corresponding to the unique identifier of the user when the user logs in an electronic device via the unique identifier of the user, recording operation information of the user on data stored in the electronic device into the determined operation listing of the user, and storing original data which is edited;
recovering each finalized data to corresponding original data according to the operation information of the user recorded in the operation listing of the user when the user logs out of the electronic device; and
recognizing the unique identifier of a current user when the current user logs into the electronic device, determining the operation listing of the current user corresponding to the unique identifier of the current user, and recovering each original data to the corresponding finalized data according to the operation information of the current user recorded in the operation listing of the current user.

9. The operation tracking method as described in claim 8, wherein the method further comprises:
determining a size of the original data;
storing the original data which is edited by hiding the original data when the size of the original data is greater than a preset value, and recovering the original data by showing the hid original data; and
storing the original data which is edited by moving the original data to a preset storage area when the size of the original data is less than or equal to the preset value, and recovering the original data by moving the original data from the preset storage area to a storage area corresponding to the storage address of the original data.

10. The operation tracking method as described in claim 8, wherein the operation information comprising information of the edited content of each original data and information of the edited content of each finalized data.

11. The operation tracking method as described in claim 10, wherein the method further comprises:
determining a permission of the current user corresponding to the unique identifier of the current user, and determining whether the permission of the current user is an administrator permission; and
replacing the information of the edited content of each original data recorded in the operation listing of each user with the ordinary permission to the information of the edited content of each finalized data edited by the current user with the administrator permission, and storing the finalized data edited by the current user with the administrator permission.

12. The operation tracking method as described in claim 10, wherein the method further comprises:
deleting the information of the edited content of each finalized data recorded in the operation listing of the current user upon recovering each original data to the corresponding finalized data.

13. The operation tracking method as described in claim 10, wherein the information of the edited content comprises a filename, a storage address, and contents, and the method further comprises:
determining the operation information of the user recorded in the operation listing of the user, and determining each finalized data according to the filename of each finalized data of the determined operation information of the user and the storage address of each finalized data of the determined operation information of the user; and
determining each original data according to the filename of each original data of the determined operation information of the user and the storage address of each original data of the determined operation information of the user, and recovering each determined finalized data and the storage address of each determined finalized data to the corresponding original data and the corresponding storage address of the original data.

14. The operation tracking method as described in claim 10, wherein the information of the edited content comprises a filename, a storage address, and contents, and the method further comprises:
determining the operation information of the current user recorded in the operation listing of the current user, and determining each original data according to the filename of each original data of the determined operation information of the current user and the storage address of each original data of the determined operation information of the current user; and
replacing the information of the edited content of each original data with the corresponding information of the edited content of the finalized data, to recover each original data to the corresponding finalized data.

15. A non-transitory storage medium storing a set of instructions, the set of instructions capable of being executed by a processor of an electronic device, causing the electronic device to perform an operation tracking method, the method comprising:
creating a database, obtaining unique identifiers of users, and adding the unique identifiers of the users and operation listings of the users into the database, each unique identifier corresponding to one operation listing;
determining the operation listing corresponding to the unique identifier of the user when the user logs in the electronic device via the unique identifier of the user, recording operation information of the user on data stored in the electronic device into the determined operation listing of the user, and storing original data which is edited;
recovering each finalized data to corresponding original data according to the operation information of the user recorded in the operation listing of the user when the user logs out of the electronic device; and
recognizing the unique identifier of a current user when the current user logs into the electronic device, determining the operation listing of the current user corresponding to the unique identifier of the current user, and recovering each original data to the corresponding finalized data according to the operation information of the current user recorded in the operation listing of the current user.

16. The non-transitory storage medium as described in claim 15, wherein the method further comprises:
determining a size of the original data;
storing the original data which is edited by hiding the original data when the size of the original data is greater than a preset value, and recovering the original data by showing the hid original data; and
storing the original data which is edited by moving the original data to a preset storage area when the size of the original data is less than or equal to the preset value, and recovering the original data by moving the original data from the preset storage area to a storage area corresponding to the storage address of the original data.

17. The non-transitory storage medium as described in claim 15, wherein the operation information comprising information of the edited content of each original data and information of the edited content of each finalized data.

18. The non-transitory storage medium as described in claim 17, wherein the method further comprises:
determining a permission of the current user corresponding to the unique identifier of the current user, and determining whether the permission of the current user is an administrator permission; and
replacing the information of the edited content of each original data recorded in the operation listing of each user with the ordinary permission to the information of the edited content of each finalized data edited by the current user with the administrator permission, and storing the finalized data edited by the current user with the administrator permission.

19. The non-transitory storage medium as described in claim 17, wherein the information of the edited content comprises a filename, a storage address, and contents, and the method further comprises:
determining the operation information of the user recorded in the operation listing of the user, and determining each finalized data according to the filename of each finalized data of the determined operation information of the user and the storage address of each finalized data of the determined operation information of the user; and
determining each original data according to the filename of each original data of the determined operation information of the user and the storage address of each original data of the determined operation information of the user, and recovering each determined finalized data and the storage address of each determined finalized data to the corresponding original data and the corresponding storage address of the original data.

20. The non-transitory storage medium as described in claim 17, wherein the information of the edited content comprises a filename, a storage address, and contents, and the method further comprises:
determining the operation information of the current user recorded in the operation listing of the current user, and determining each original data according to the filename of each original data of the determined operation information of the current user and the storage address of each original data of the determined operation information of the current user; and
replacing the information of the edited content of each original data with the corresponding information of the edited content of the finalized data, to recover each original data to the corresponding finalized data.
